(19) United States
(12) Patent Application Publication
(10) Pub. No.: US 2018/0150704 A1
(43) Pub. Date: May 31, 2018

(54) METHOD OF DETECTING PEDESTRIAN AND VEHICLE BASED ON CONVOLUTIONAL NEURAL NETWORK BY USING STEREO CAMERA

(71) Applicant: Kwangwoon University Industry-Academic Collaboration Foundation, Seoul (KR)

(72) Inventors: Gyu-Cheol LEE, Seoul (KR); Jisang YOO, Seoul (KR)

(21) Appl. No.: 15/824,435

(22) Filed: Nov. 28, 2017

Related U.S. Application Data
(60) Provisional application No. 62/426,871, filed on Nov. 28, 2016.

(51) Int. Cl. G06K 9/00; H04N 21/44; G06K 9/62; G06K 9/20; G06K 9/46

(52) U.S. Cl. CPC G06K 9/00805; H04N 21/44008; G06K 9/00201; G06K 9/209; G06K 9/4642; G06K 9/6256

(57) ABSTRACT

Provided is a method of detecting pedestrians and vehicles based on a convolutional neural network by using a stereo camera, for generating a disparity video through stereo matching in a video photographed by the stereo camera, detecting object candidates by using the disparity image, and detecting the pedestrians and the vehicles through an object detection process for the detected candidate. The method includes receiving a stereo video; acquiring a disparity video from the stereo video using stereo matching to convert the disparity video into a depth video; extracting object candidates by analyzing a histogram of the depth video; and detecting an object by using a convolutional neural network to be detected among the object candidates. Object candidates are detected using disparity video in advance, and one of the object candidates is detected whether it is a pedestrian or a vehicle, such that less time is required.

### REFERENCES TO RELATED APPLICATIONS

This is a non-provisional application which claims the benefit of a provisional application No. 62/426,871 filed Nov. 28, 2016, of which disclosure is entirely incorporated herein by reference.

### BACKGROUND OF THE INVENTION

### 1. Field of the Invention

The present invention relates to a method of detecting a pedestrian and a vehicle based on a convolutional neural network by using a stereo camera, in which a disparity video is generated through stereo matching from a video photographed by the stereo camera, object candidates are detected by using the disparity video, and the pedestrian and the vehicle are detected by performing an object detection process with respect to the detected candidate.

Particularly, the present invention relates to a method of detecting a pedestrian and a vehicle based on a convolutional neural network by using a stereo camera, in which the pedestrian and the vehicle are detected through Alexnet, which is a convolutional neural network (CNN), by reducing a structure of the conventional Alexnet into a structure suitable for DB of the pedestrian or vehicle.

### 2. Description of the Related Art

Nearly 1.3 million people die from traffic accidents each year, on average 3,287 deaths a day. Additional 20-50 million people are injured or disabled (see reference document 1). Especially, about 24% of all traffic accidents are pedestrian-vehicle crashes and accidents involving pedestrians have a much greater risk of producing fatal results. Therefore, sensible solution need to be considered in order to prevent accidents in the future and to improve the safety of the pedestrian and driver.

In this situation, object detection system has become an important issue in intelligent automobile and surveillance system, which is monitoring surrounding element, such as pedestrian, vehicle and risk element. With the development of computer vision, video-based surveillance systems have made great advances. This system makes it possible that the computer can automatically locate, recognize and track the object.

Volvo, Mercedes Benz, BMW and other vehicle manufacturer offer object detection systems to prevent traffic accident. Volvo has developed the City Safety System (see reference document 2), an auto brake technology, which assists in reducing or avoiding traffic accidents at speeds up to 30 km/h (19 mph). Later models using City Safety Generation II can stop at 50 km/h (31 mph). This system detects pedestrians on the road ahead, whether they are stationary or moving into your path. BMW has developed the Night Vision (see reference document 3) to detect an object in the night. Night Vision uses an infrared camera to see up to 300 m ahead of the vehicle and warns the driver of pedestrians on the road. Benz has developed a Pre-Safe Brake System (see reference document 4) that can recognize pedestrians using a stereo camera. At speeds of up to 50 km/h, it can help to avoid a collision with a pedestrian.

As mentioned above, object detection technology has been one of the most emerging technologies. However, the performance of existing object detection systems is sensitive to camera noise, object occlusion and weather. Moreover, the majority of the system is to use only single camera, which incapable of considering the surrounding environment.

Oh has studied on a method of actively responding to the movement of a target or an obstacle by using a moving system using a single camera to find and track a region of interest that needs to be efficiently monitored (see reference document 5). Ego-motion of a traveling system can be predicted by tracking corner points by using the Lucas-Kanade algorithm from successive images. A region having a different movement is determined as an obstacle or a target and set as a region of interest (ROI). The set ROI is tracked using a particle filter and a Kalman filter and the trajectory is predicted, such that the system can actively respond to the movement of the target. However, because one camera is used, the distance between the camera and the object cannot be measured. In addition, there is a problem that the object is not extracted due to the nature of the algorithm when the motion of the vehicle is similar to the motion of the object. Since the object is not classified separately, it is impossible to know whether the detected object is a vehicle, a pedestrian, or another body.

In addition, Yang used a method of detecting a pedestrian through a camera image to detect a pedestrian in an external environment by using the feature of a histogram of oriented gradient (HoG) (see reference document 7). Then, Yang proposed an algorithm for defining and tracking behavior patterns of the pedestrian and determining whether the pedestrian walks across. Yang proposed a processing speed suitable for real time by processing GPU and CPU in parallel. However, because one camera is used, the distance between the object and the camera cannot be measured. Although the HoG is used as a method of searching for the pedestrian, it takes a long time because the search range due to the nature of the HoG is the entire images.

### REFERENCE DOCUMENTS

[1] D. M. Gavrila, “Sensor-based pedestrian protection,” IEEE Intelligent Systems, Vol. 16, No. 6, pp. 77-81 (2001).
[2] Volvo City Safety system [Internet]. Available: http://www.volvocars.com/us/about/our-innovations/intellisafe
[3] BMW Night Vision System [Internet]. Available: http://www.bmw.com/com/en/insights/technology/connecteddrive/2013/
[4] Benz Pre-Safe Brake System [Internet]. Available: http://techcenter.mercedes-benz.com/en/pre_safe_system/detail.html
[5] S. H. Oh, “Method for detection regions of interest and active surveillance assistance in the mobile ground reconnaissance system”, Journal of KIIT, Vol. 12, No. 6, pp. 31-38 (2014).
[6] L. Zhao and C. Thorpe, “Stereo and neural network-based pedestrian detection”, IEEE Trans. Intelligent Transportation System, Vol. 1, No. 3, pp. 148-154 (2000).
[7] Sung-Min Yang and Kang-Hyun Jo, “HOG Based Pedestrian Detection And Behavior Pattern Recognition For Traffic Signal Control”, Journal of Institute of Control, Robotics and Systems, Vol. 19, No. 11, November 2013, pp. 1017-1021 (5 pages).

### SUMMARY OF THE INVENTION

To solve the above-mentioned problems, the present invention provides a people counting method operated in real time in an embedded environment, and more particularly, a method of detecting a pedestrian and a vehicle based on a convolutional neural network by using a stereo camera, in which a background image is generated by applying a brightness variation characteristic of an image without excessive learning or parameter adjustment.

Particularly, the present invention provides a method of detecting a pedestrian and a vehicle based on a convolutional neural network by using a stereo camera, in which a pedestrian candidate group region is generated using a background model to perform a pedestrian detection based on the CNN having the above region as input.

In addition, the present invention provides a method of detecting a pedestrian and a vehicle based on a convolutional neural network by using a stereo camera, in which a pedestrian candidate group having high reliability is generated through the background model instead of the conventional region proposal scheme, and a CNN-based pedestrian classification model having the group as an input is used, especially, an optimal CNN structure is used.

To achieve the above-mentioned object, the present invention relates to a method of detecting a pedestrian and a vehicle based on a convolutional neural network by using a stereo camera, which counts pedestrians in video composed of successive frames, and includes the steps of: (a) receiving a stereo video; (b) acquiring a disparity video from the stereo video using stereo matching to convert the disparity video into a depth video; (c) extracting object candidates by analyzing a histogram of the depth video; and (d) detecting an object by using a convolutional neural network to be detected among the object candidates.

In addition, according to the method of detecting the pedestrian and the vehicle based on the convolutional neural network by using the stereo camera of the present invention, in step (c), a histogram distribution is made for each row or column of the depth video, a non-uniform pixel value range is extracted, and a region having a corresponding pixel value range is detected as an object candidate.

In addition, according to the method of detecting the pedestrian and the vehicle based on the convolutional neural network by using the stereo camera of the present invention, in step (d), the convolutional neural network uses Alexnet.

In addition, according to the method of detecting the pedestrian and the vehicle based on the convolutional neural network by using the stereo camera of the present invention, an optimal structure is constructed by performing a grid search and a brute-force algorithm with respect to the Alexnet.

In addition, the present invention relates to a computer-readable recording medium recorded therein with a program for executing a method of detecting a pedestrian and a vehicle based on a convolutional neural network by using a stereo camera.

As mentioned above, according to the method of detecting the pedestrian and the vehicle based on the convolutional neural network by using the stereo camera of the present invention, object candidates are detected using disparity video in advance, and one of the object candidates is detected whether it is a pedestrian or a vehicle, so that less time can be consumed. In other words, because a long time is required when the object is detected using the entire video, a histogram in the disparity video is extracted in the vertical direction and analyzed, and the region where the histogram is not uniform is extracted as the object candidate.

In addition, according to the method of detecting the pedestrian and the vehicle based on the convolutional neural network by using the stereo camera of the present invention, when DB of another object exists in addition to the pedestrian and the vehicle, the pedestrian and the vehicle are recognized by using the convolutional neural network, thus the corresponding object can be recognized through a training process, so that the recognition rate can be improved as compared with the HoG.

In other words, because the object is detected with respect to the extracted candidate region by using the AlexNet which is the convolutional neural network, the recognition rate can be improved while shortening the time.

A structure of the AlexNet is optimized for an ImageNet DB, which includes more than 15 million high-resolution images in more than 22,000 categories. Since the structure of AlexNet is too large to recognize only the two categories of the vehicle and the pedestrian, the structure has been newly designed to reduce the size and improve the speed.

### BRIEF DESCRIPTION OF THE DRAWINGS

FIG. 1 is a view showing an entire system configuration for carrying out the present invention.

FIG. 2 is a flow chart illustrating a method of detecting a pedestrian and a vehicle based on a convolutional neural network by using a stereo camera according to an embodiment of the present invention.

FIG. 3A is a disparity image for a histogram analysis according to an embodiment of the present invention.

FIG. 3B is a graph for a histogram of an object row of FIG. 3A.

FIG. 3C is a graph for a histogram of a non-object row of FIG. 3A.

FIG. 4 is a CNN result image according to an embodiment of the present invention.

FIG. 5 is a table showing performance according to the present invention through experiments.

FIG. 6 is a table showing performance according to the present invention compared with other conventional methods.

### DETAILED DESCRIPTION OF THE INVENTION

Hereinafter, embodiments for carrying out the present invention will be described in detail with reference to the accompanying drawings.

In addition, the same reference numeral indicates the same part in the description of the present invention, and repetitive description thereof will be omitted.

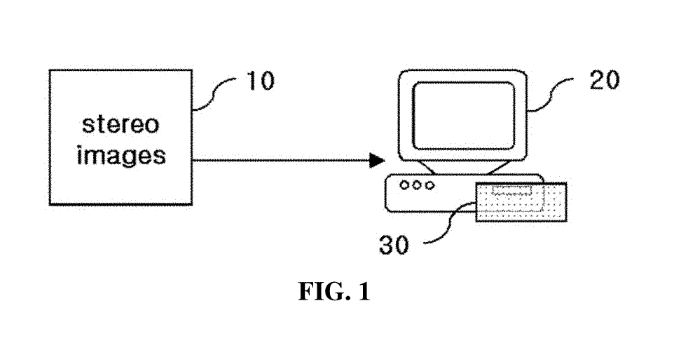

First, examples of the entire system configuration for carrying out the present invention will be described with reference to FIG. 1.

As shown in FIG. 1, the method of detecting the pedestrian and the vehicle based on the convolutional neural network by using the stereo camera of the present invention may be implemented as a program system in a computer terminal 20, in which a stereo video (or image) 10 obtained by photographing a pedestrian or a vehicle is received to detect the pedestrian or the vehicle with respect to the video (or image). In other words, the method of detecting the pedestrian and the vehicle may be configured in a program, and installed and executed in the computer terminal 20. The program installed in the computer terminal 20 may be operated as one program system 30.

Meanwhile, in another embodiment, the method of detecting the pedestrian and the vehicle according to the present invention may be configured as one electronic circuit such as an application specific integrated circuit (ASIC) in addition to be configured as the program and operated in a general-purpose computer. Alternatively, the method may be developed as a dedicated computer terminal 20 that exclusively processes a task of detecting a pedestrian or a vehicle with respect to the stereo video. Hereinafter, it will be referred to as a pedestrian and vehicle detection system 30. Other possible forms may also be implemented.

Meanwhile, a video 10 is a stereo image photographed by two cameras. In other words, two cameras are used to measure a distance between the cameras and an object. In addition, the stereo video 10 is composed of successive frames based on time. One frame has one image. In addition, the video 10 may have one frame (or image). In other words, the video 10 may also correspond to one image.

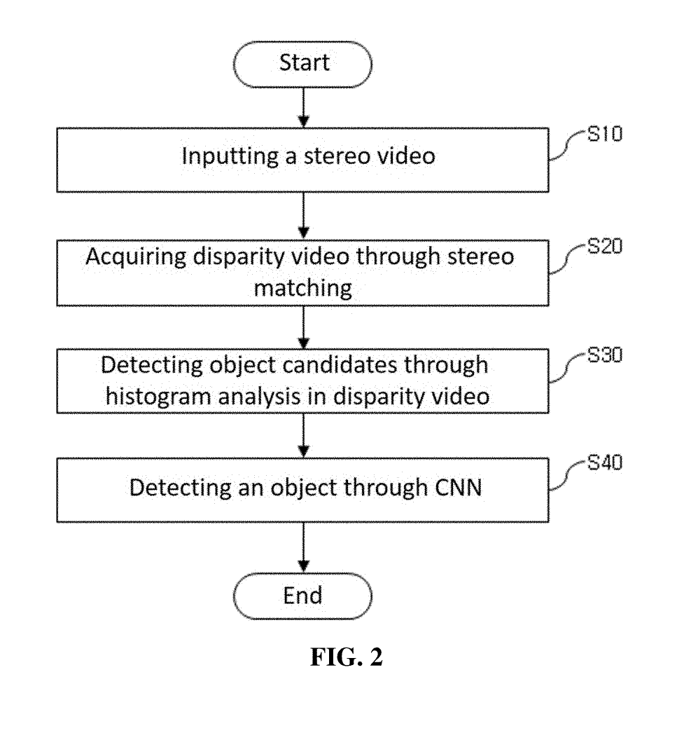

Next, the method of detecting the pedestrian and the vehicle based on the convolutional neural network by using the stereo camera according to an embodiment of the present invention will be described in more detail with reference to FIG. 2.

As shown in FIG. 2, the method of detecting the pedestrian and the vehicle based on the convolutional neural network by using the stereo camera according to the present invention includes receiving a stereo video (S10), acquiring a disparity video (S20), detecting object candidates (S30), and detecting an object (S40).

First, the stereo video is inputted (S10). The stereo video is a video photographed by the two cameras.

Next, a disparity video is acquired from the stereo video by using stereo matching (S20). The disparity video may be converted into a depth video by using a camera parameter. The depth video is a video in which a distance from the camera to the object is expressed as a value from 0 to 255.

Next, a histogram of the obtained depth video is analyzed to extract the object candidates (S30).

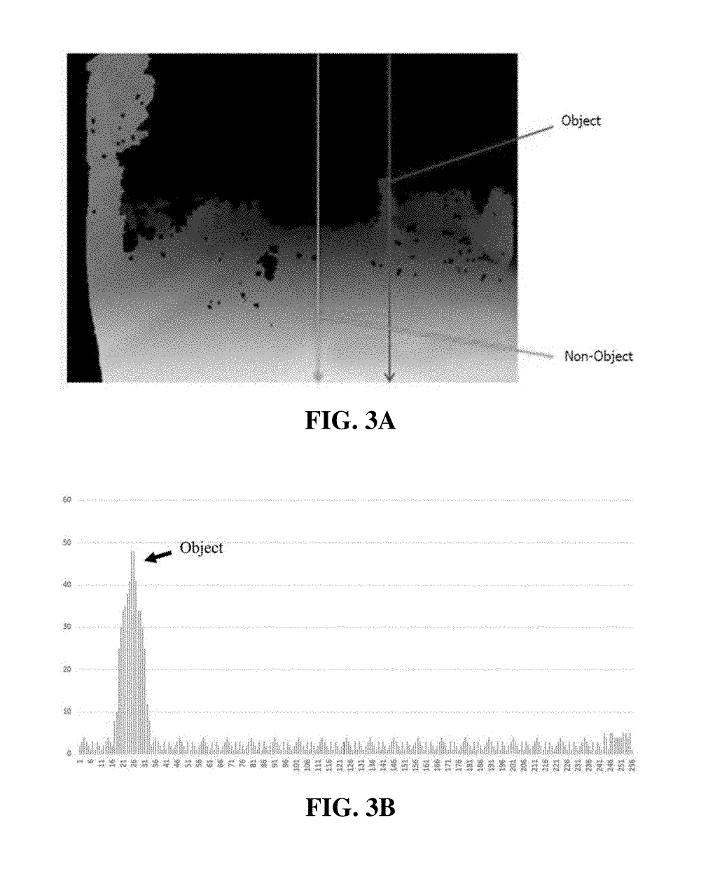

When the histogram is analyzed in the vertical (or horizontal) direction of the depth video, the histogram of a road region is uniformly distributed due to geometrical characteristics of the camera installed in a vehicle. However, in the histogram of an object region, the distribution tends to be noticeably higher at specific pixel values. FIG. 3 shows a distribution of a histogram in the vertical direction with respect to the road area and the object area. The “Non-object” arrow indicates the road region, and it shows that the distribution of the histogram is uniform (FIG. 3C). Whereas, the “Object” arrow indicates the pedestrian region, and it shows that the distribution of the histogram is concentrated on specific pixel values (FIG. 3B). The region having a corresponding pixel value is detected as an object candidate.

Specifically, a threshold value is set in advance. The threshold value is acquired by performing experimental results. All pixel values equal to or greater than the threshold value are extracted, labeled, and set as object candidates.

In other words, all pixels having the corresponding pixel value are extracted by obtaining a histogram for each row, and specifying a range of pixel values where the distribution is not uniform. The column including the object has a high value in the range of specific pixel values in the histogram.

The proposed scheme of detecting object candidates may detect faster than a grid scan scheme of searching the entire video from an upper left end to a lower right end of the video. When the grid scan scheme is used, tens of thousands of objects are required to be processed as candidates and recognition processes are required to be performed for each of the candidates, whereas the proposed scheme is more efficient because the recognition process is performed only on extracted object candidates.

The method of detecting the object candidates according to the present invention may detect faster than the grid scan scheme of searching the entire video from an upper left end to a lower right end of the video. When the grid scan scheme is used, tens of thousands of objects are required to be processed as candidates and recognition processes are required to be performed for each of the candidates, whereas the method according to the present invention is more efficient because the recognition process is performed only on extracted object candidates.

Next, the pedestrian and the vehicle, which are targets to be detected among the object candidates, are detected using AlexNet (S40). Basically, the structure of AlexNet is optimized for the ImageNet DB, which includes more than 15 million high-resolution images in more than 22,000 categories. Accordingly, since the structure of AlexNet is too large to recognize only the two categories of the vehicle and the pedestrian, the structure is required to be newly designed to reduce the size and improve the speed.

Model selection is a process in which a developer finds out a hyper parameter having an optimal neural network structure. The hyper parameter of the neural network includes the number of hidden layers, the type of hidden neurons and activation functions, and the structure of pooling and convolution layer. In the proposed method, the optimal structure for the application is constructed by performing the grid search and the brute-force algorithm.

According to the grid search, a hyper parameter space is divided in a grid form, a validation error is calculated for each grid point, and the hyper parameter indicating the lowest error among all grid points is selected. In other words, the optimal hyper parameter is selected by continuously performing experiments while changing hyper parameters. The brute-force algorithm is similar.

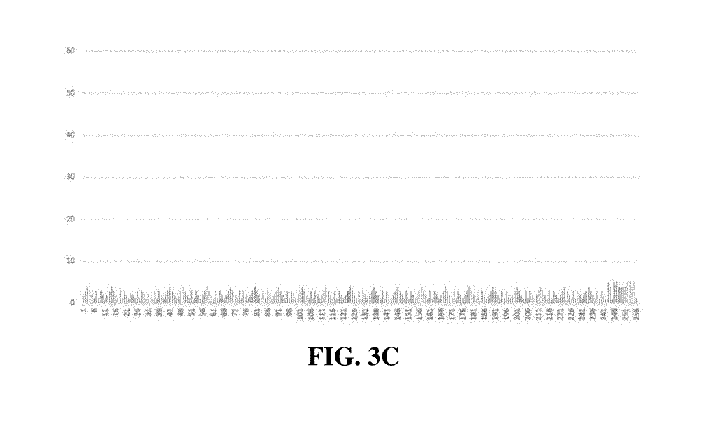

Recognition on the object candidates is performed by using AlexNet optimized for the pedestrian and the vehicle. FIG. 4 visualizes object detection after applying CNN on the object candidates. The central box indicates the pedestrian and the right box indicates the vehicle.

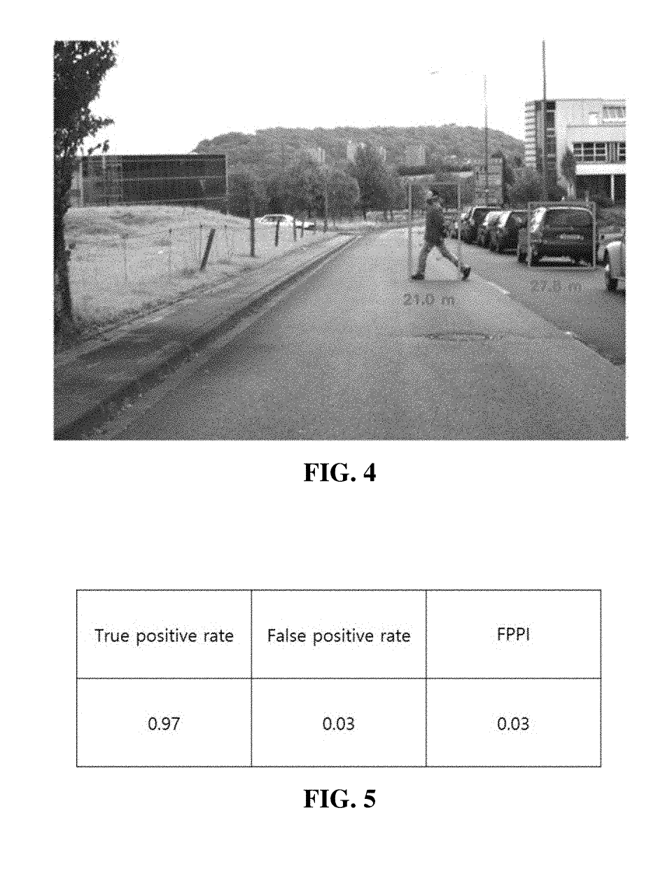

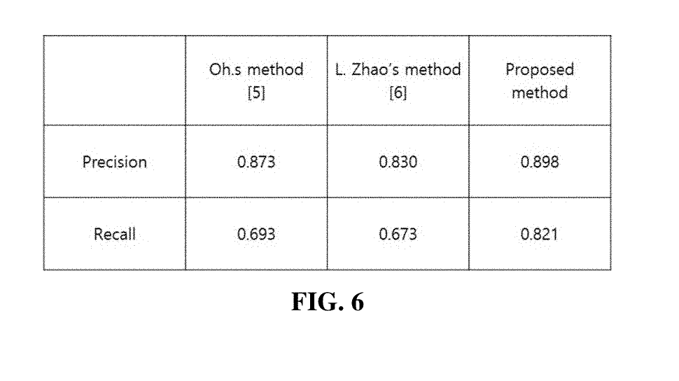

Next, the effects of the present invention through experimental results will be described with reference to FIGS. 5 and 6.

FIG. 5 shows the performance evaluation of the proposed method in detecting objects. In order to evaluate if the object is detected correctly, the true positive rate, false positive rate and the false positives per image (FPPI) are used. True positive rate is the rate at which moving objects are correctly detected and false positive rate represents the rate at which wrong objects are detected. FPPI is the average false positive number per image.

FIG. 6 shows the comparison of the performance evaluation result of the proposed method and other methods using the Daimler Pedestrian Dataset. Precision represents the ratio of correctly detected objects out of objects detected using the system. Recall represents the ratio of correctly detected objects out of all the objects in the input image. The proposed method's recall ratio low because the disparity value of small objects far away from camera is not accurate. However, the precision rate is the highest (88.1%) out of all the methods and that is because of the object candidate selection using stereo camera.

We proposed a method for detecting objects using a stereo camera. First, disparity map is obtained by using stereo matching. Then, the histogram in the depth map is analyzed by row and the pixel with the disparity value higher than the threshold value is selected as an object candidate. Finally, the object is determined by the CNN. Experimental results how that the proposed method outperformed the other existing methods in moving objects.

The present invention implemented by the inventor has been described in detail according to the above embodiments, however, the present invention is not limited to the embodiments and various modifications are available within the scope without departing from the invention.

What is claimed is:

1. A method of detecting a pedestrian and a vehicle based on a convolutional neural network by using a stereo camera, the method comprising:
(a) receiving a stereo video;
(b) acquiring a disparity image from the stereo video by using stereo matching and converting the disparity video into a depth video;
(c) extracting object candidates by analyzing a histogram of the depth video; and
(d) detecting an object by using the convolutional neural network to be detected among the object candidates.

2. The method of claim 1, wherein, in step (c), a histogram distribution is made for each row or column of the depth video, a non-uniform pixel value range is extracted, and a region having a corresponding pixel value range is detected as an object candidate.

3. The method of claim 1, wherein, in step (d), the convolutional neural network uses Alexnet.

4. The method of claim 3, wherein an optimal structure is constructed by performing a grid search and a brute-force algorithm with respect to the Alexnet.

5. A non-transitory computer-readable recording medium recorded therein with a program for executing the method according to claim 1.
